(19) United States
(12) Patent Application Publication
(10) Pub. No.: US 2025/0091179 A1
(43) Pub. Date: Mar. 20, 2025

(54) MULTI-SPEED POWERED RATCHET TOOL

(71) Applicant: MILWAUKEE ELECTRIC TOOL CORPORATION, Brookfield, WI (US)

(72) Inventors: Jordan P. Gilsinger, Sussex, WI (US); Kyle A. Marten, Plymouth, WI (US)

(21) Appl. No.: 18/885,124

(22) Filed: Sep. 13, 2024

Related U.S. Application Data
(60) Provisional application No. 63/583,030, filed on Sep. 15, 2023.

(51) Int. Cl. B25B 21/00

(52) U.S. Cl. CPC B25B 21/004; B25B 21/008

(57) ABSTRACT

A power tool comprising a housing, a motor disposed in the housing, a battery, a head coupled to the housing, a transmission, a shift actuator, and a spring lever. The housing includes a battery receptacle configured to receive the battery. The motor includes a motor shaft driven by the motor about a first axis. The battery powers the motor. The head containing a ratchet mechanism, which is configured to drive an output drive about an axis orthogonal to the first axis. The transmission is configured to transmit rotation from the motor shaft to the ratchet mechanism and is shiftable between a high-speed, low-torque configuration and a low-speed, high torque configuration. The shift actuator is positioned partially within the housing and is moveable along an axis parallel to the first axis. The spring lever is coupled to the head and transmits motion from the shift actuator to the transmission.

### CROSS-REFERENCE TO RELATED APPLICATIONS

This application claims priority to U.S. Provisional Patent Application No. 63/583,030, filed on Sep. 15, 2023, the entire contents of which are incorporated herein by reference.

### FIELD

The present disclosure relates to power tools, and more particularly to powered ratchet tools.

### BACKGROUND

Powered ratchet tools may be driven in a forward direction or an opposite direction to apply torque to a fastener for tightening and loosening operations. Powered ratchet tools are typically powered by an electrical source, such as a DC battery, a conventional AC source, or pressurized air.

### SUMMARY

In some aspects, the techniques described herein relate to a power tool including: a housing including a battery receptacle; a motor disposed within the housing, the motor including a motor shaft driven by the motor about a first axis; a battery configured to be coupled to the battery receptacle to power the motor; a head coupled to the housing, the head containing a ratchet mechanism configured to rotate an output drive about an output axis orthogonal to the first axis, the head including a plurality of internal teeth formed on an inner circumferential surface of the head; a transmission configured to transmit rotation from the motor shaft of the motor to the ratchet mechanism, the transmission shiftable between a high-speed, low-torque configuration and a low-speed, high-torque configuration, the transmission including: a first planetary stage configured to receive torque from the motor shaft, and a second planetary stage configured to receive torque from the first planetary stage, the second planetary stage includes: a plurality of planet gears configured to receive torque from an output of the first planetary stage, a moveable ring gear configured to engage the plurality of planet gears, the moveable ring gear axially moveable along the first axis, the moveable ring gear including a plurality of outer teeth formed on an outer circumferential surface configured to engage the plurality of internal teeth of the head, and a planet carrier configured to transfer torque to the ratchet mechanism; a shift actuator positioned partially within the housing, the shift actuator is moveable along an axis parallel to the first axis; and a spring lever coupled to the head, the moveable ring gear, and the shift actuator, the spring lever configured to transmit motion of the shift actuator to the moveable ring gear to shift the transmission between the high-speed, low-torque configuration and the low-speed, high-torque configuration, wherein the spring lever is resiliently deformable in response to misalignment between outer teeth of the moveable ring gear and the internal teeth of the head.

In some aspects, the techniques described herein relate to a power tool including: a motor including a motor shaft rotating around a first axis; a ratchet mechanism configured to receive torque from the motor to rotate an output drive; and a transmission transmitting torque from the motor shaft of the motor to the ratchet mechanism, the transmission includes a high-speed, low-torque configuration and a low-speed, high-torque configuration, the transmission including: a first planetary stage configured to receive torque from the motor shaft, and a second planetary stage configured to receive torque from the first planetary stage, the second planetary stage includes: a plurality of planet gears configured to receive torque from an output of the first planetary stage, a moveable ring gear configured to engage the plurality of planet gears, the moveable ring gear is axially moveable along the first axis, the moveable ring gear including a plurality of outer teeth formed on an outer circumferential surface, and a planet carrier configured to transfer torque to the ratchet mechanism.

In some aspects, the techniques described herein relate to a power tool including: a housing; a head coupled to the housing, the head housing a ratchet mechanism configured to rotate an output drive; a motor disposed within the housing, the motor including a motor shaft driven by the motor about a first axis; a transmission configured to transmit rotation from the motor shaft of the motor to the ratchet mechanism, the transmission shiftable between a high-speed, low-torque configuration and a low-speed, high-torque configuration; a shift actuator positioned within the housing, the shift actuator is configured to move parallel to the first axis; and a spring lever coupled to the head, the shift actuator, and a portion of the transmission, the spring lever configured to transmit motion of the shift actuator to a portion of the transmission to shift the transmission between the high-speed, low-torque configuration and the low-speed, high-torque configuration.

Other features and aspects of the disclosure will become apparent by consideration of the following detailed description and accompanying drawings.

### BRIEF DESCRIPTION OF THE DRAWINGS

FIG. 1 is a perspective view of a powered ratchet tool.

FIG. 2 is a perspective view of a portion of the powered ratchet tool of FIG. 1, with a housing of the powered ratchet tool hidden.

FIG. 3 is a perspective view of the portion of the powered ratchet tool of FIG. 2, with a head of the powered ratchet tool hidden.

FIG. 4A is a side view of the portion of powered ratchet tool of FIG. 3 with a shift actuator in a first position.

FIG. 4B is a section view of the portion of the powered ratchet tool of FIG. 4A.

FIG. 5A is a side view of the portion of powered ratchet tool of FIG. 3 with a shift actuator in a second position.

FIG. 5B is a section view of the portion of the powered ratchet tool of FIG. 4B.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

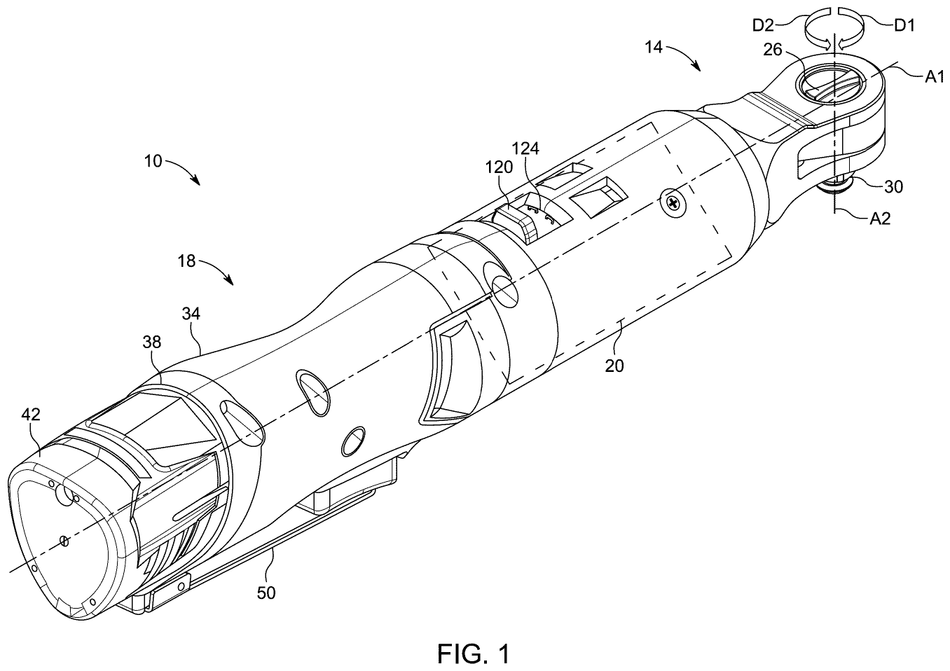

FIG. 1 illustrates a powered ratchet tool 10 in accordance with an embodiment of the disclosure. In the illustrated embodiment, the powered ratchet tool 10 is configured to transmit torque to a fastener (not show) through a tool bit to tighten or loosen the fastener. The powered ratchet tool 10 includes a head 14, a housing 18, and a drive train 20 supported within the housing.

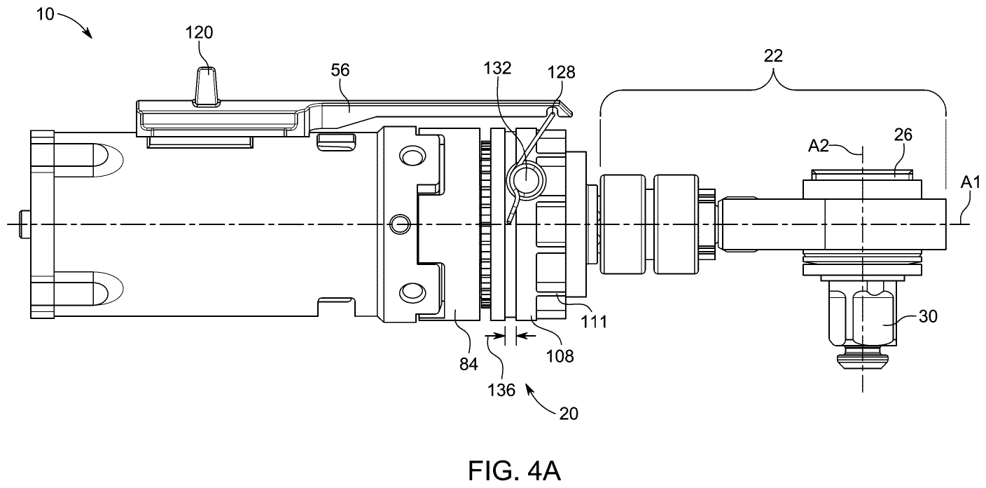

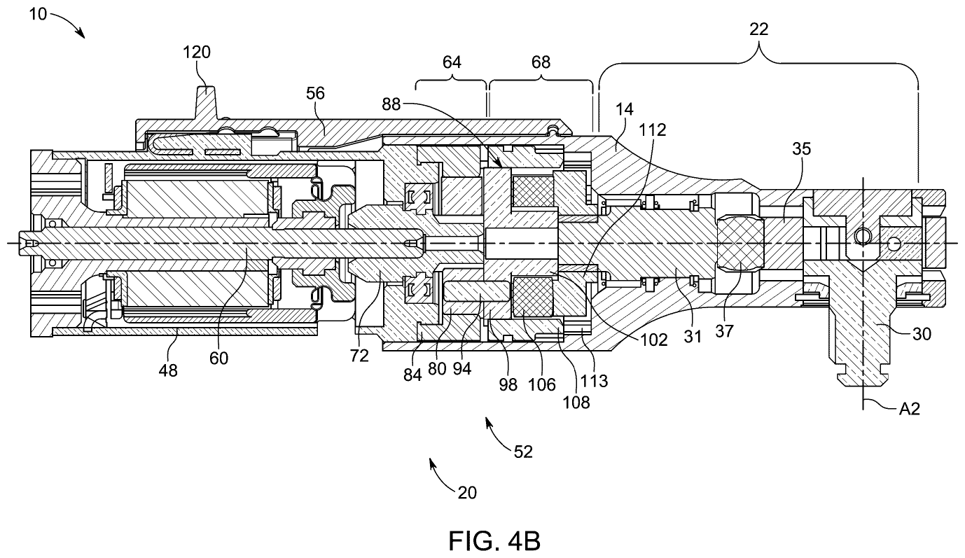

As shown in FIG. 1, the housing 18 of powered ratchet tool 10 extends along a first axis A1. The housing 18 comprises a grip portion 34 spanning a portion of the housing 18 and a battery receptacle 38 located at an end of the housing 18 opposite the head 14. The grip portion 34 is positioned adjacent to the battery receptacle 38 and is configured to be held by a user during operation of the tool 10. The battery receptacle 38 receives a removable battery pack 42 and electrically connects the battery pack 42 to an electric motor 48 (FIG. 4B), which in the illustrated embodiment is a brushless, direct-current, outer-rotor motor, via suitable electrical and electronic components, such as a PCBA containing MOSFETs, IGBTs, or the like. The motor 48 is disposed within the housing. Operation of the motor 48 can be controlled by an actuator 50, such as a paddle, trigger, or any other suitable actuator. The battery pack 42 may be a 12-volt power tool battery pack that includes three lithium-ion battery cells. Alternatively, the battery pack 42 may include fewer or more battery cells to yield any of a number of different output voltages (e.g., 14.4 volts, 18 volts, etc.). Additionally or alternatively, the battery cells may include chemistries other than lithium-ion such as, for example, nickel cadmium, nickel metal-hydride, or the like.

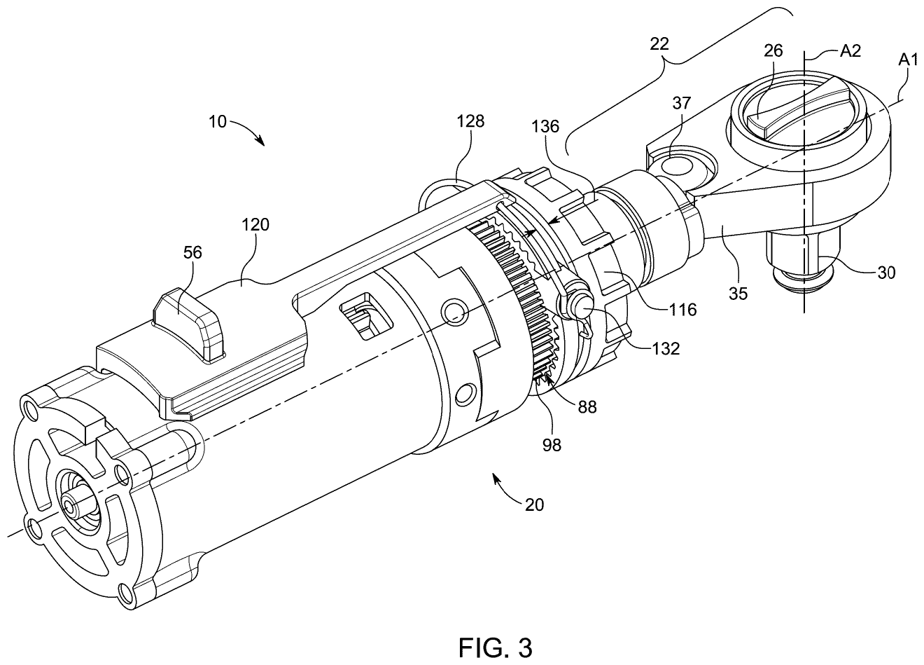

Referring to FIGS. 1-4B, the head 14 extends from the housing 18 and supports a ratchet mechanism 22 (FIG. 3) and a forward/reverse switch, in the form of a knob 26. The ratchet mechanism 22 converts a rotational output of the drive train 20 about the first axis A1 to rotation of an output drive 30 about a second axis A2, which is orthogonal to the first axis A1 in the illustrated embodiment. For example, the illustrated ratchet mechanism 22 includes a crank shaft 31 coupled to an output of the drive train 20 (FIG. 4B). The crank shaft 31 supports an eccentrically-mounted spherical bearing 37, which engages a yoke 35 of the ratchet mechanism 22. Accordingly, rotation of the crank shaft 31 reciprocates the yoke 35 back and forth about the second axis A2. The yoke 35 is coupled to the output drive 30 by a pawl (not shown), which selectively couples the output drive 30 for co-rotation with the yoke 35 about the second axis A2 in a selected direction, while permitting relative rotation between the output drive 30 and the yoke 35 in a direction opposite the selected direction.

Referring again to FIG. 3, the knob 26 is rotatable to change the selected direction. As such, when the knob 26 is in a first position, the ratchet mechanism 22 transmits torque to an output drive 30 in a first direction D1 around the output axis A2, and the output drive 30 can rotate freely in a second direction D2. When the knob 26 is in a second position, the rachet mechanism 22 transmits torque to an output drive 30 in the second direction D2 around the output axis A2, and the output drive 30 can rotate freely in the first direction D1. In the illustrated embodiment, the knob 26 is rotatable about the second axis A2; however, in other embodiments, the knob 26 may be positioned elsewhere on the head 14 and offset from the second axis A2.

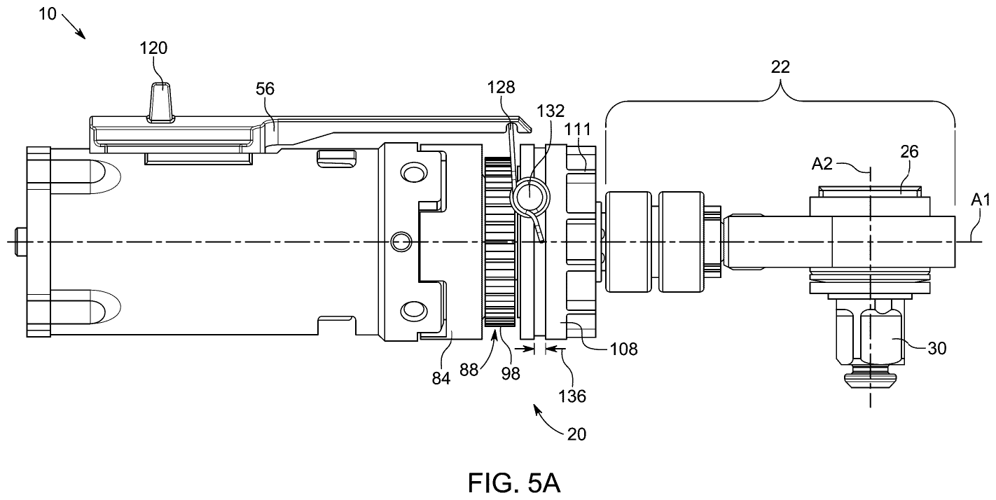

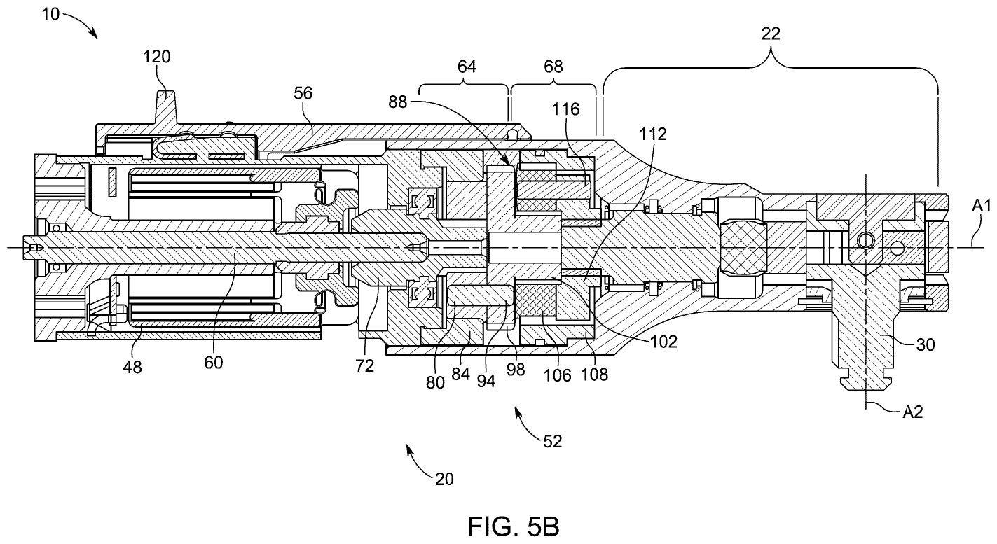

FIGS. 4A-5B show a portion of the powered ratchet 10 with the housing 18 removed, which shows the drive train 20. The drive train 20 is configured to transmit torque to the rachet mechanism 22. The drive train 20 includes the motor 48, a multi-speed transmission 52, and a shift actuator 56.

The transmission 52 is coupled to an output shaft 60 of the motor 48. The output shaft 60 is driven by the motor 48 to rotate about the first axis A1. In the illustrated embodiment, the transmission 52 has at least a high-speed, low-torque configuration (FIG. 4A-B), and a low-speed, high-torque configuration (FIG. 5A-B). The illustrated transmission 52 includes a first planetary stage 64 coupled to the motor output shaft 60 and a second planetary stage 68 coupled the first planetary stage 64 and the crank shaft 31 (FIG. 4B). In other embodiments, the transmission 52 may include a different number of stages or other gear arrangements.

As seen in FIGS. 4B and 5B, the first planetary stage 64 includes a first sun gear or pinion 72, a first plurality of planet gears 80, a stationary ring gear 84, and a first planet carrier 88. The first sun gear 72 is coupled to the motor output shaft 60 and rotates around the first axis A1. The first plurality of planet gears 80 are meshed with both the first sun gear 72 and the stationary ring gear 84 and are supported by the first planet carrier 88 through a first plurality of pins 94. The first planet carrier 88 comprises an outer geared portion 98 (FIG. 3) and a sun gear portion 102 configured to engage the second planetary stage 68.

Also shown in FIGS. 4B and 5B, the second planetary stage 68 includes a second plurality of planet gears 106, a moveable ring gear 108, and a second planet carrier 112. The second plurality of planet gears 106 engages the sun gear portion 102 of the first planet carrier 88 and the moveable ring gear 108. The moveable ring gear 108 engages the second plurality of planet gears 106 and is moveable along the first axis A1 to selectively engage teeth 111 (FIG. 4A) on an outer circumferential surface of the moveable ring gear 108 with internal teeth 113 (FIG. 4B) formed within (i.e., on an inner circumferential surface of) the head 14. The second planet carrier 112 supports the second plurality of planet gears 106 through a second plurality of pins 116 and is coupled for co-rotation with the crank shaft 31 (e.g., via a spline fit, press fit, or other suitable arrangement).

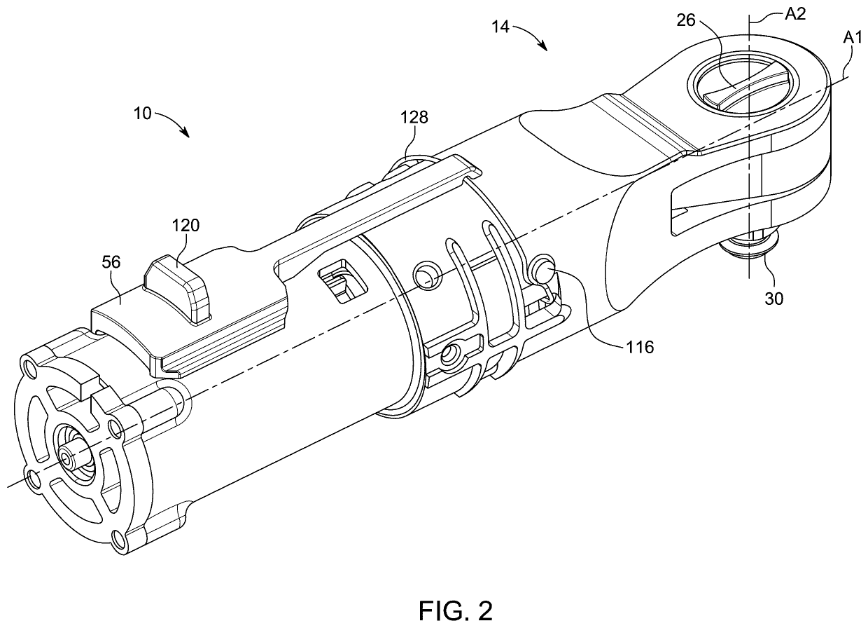

The shift actuator 56 includes a user actuatable portion 120 extending through an opening 124 in the housing 18 (FIG. 1). In other embodiments, the user actuatable portion 120 is recessed in the opening 124 or in line with the housing 18. The shift actuator 56 is coupled to the moveable ring gear 108 through a spring lever 128. As shown in FIGS. 2 and 3, the spring lever 128 is rotatably coupled to a post 132 formed on the head 14 and a portion of the spring lever 128 extends through the head 14 to engage the moveable ring gear 108. Specifically, ends of the spring lever 128 engage an annular recess 136 in the moveable ring gear 108 to axially move the ring gear 108 in response to rotation of the spring lever 128 about the post 132. The spring lever 128 is resiliently deformable to permit slight delays in shifting, which may reduce jamming.

In operation, the user engages the actuator 50 to energize the motor 48 and rotate the output shaft 60. The rotation of the output shaft 60 is transferred to the first planetary stage 64 of the transmission 52. In particular, the first sun gear 72 co-rotates with the output shaft 60 and drives the first plurality of planet gears 80, which orbit inside the first ring gear 84 and drive rotation of the first planet carrier 88.

Operation of the second planetary stage 68 depends upon on the position of the shift actuator 56. If the shift actuator 56 is in a first or forward position (FIGS. 4A-B), the teeth 111 on the moveable ring gear 108 are separated from the teeth 113 in the head 14, such that the moveable ring gear 108 may rotate about the first axis relative to the head 14, effectively disabling the gear reduction of the second planetary stage 68. Accordingly, the powered ratchet tool 10 operates at a relatively higher speed and lower output torque, equal to an output of first planetary stage 64, in this position of the shift actuator 56. When the shift actuator 56 is moved to a second or rearward position (FIGS. 5A-B), in a direction parallel to the axis A1, the spring lever 128 pivots and drives the movable ring gear 108 forward along the axis A1. This engages the outer teeth 111 of the moveable ring gear 108 with the inner teeth 113 of the head 14, locking the moveable ring gear 108 against rotation relative to the head 14. If the outer teeth 111 of the moveable ring gear 108 and the inner teeth 113 of the head 14 are not aligned, the moveable ring gear 108 faces resistance to axial movement, which causes the spring lever 128 to be resiliently deformed. As a result, a biasing force of the spring lever 128 presses moveable ring gear 108 towards the head 14, until the teeth 111 and inner teeth 113 are aligned and can mesh. In other words, the spring lever 128 permits a delay between moving the user actuatable portion 120 and a resulting movement of the ring gear 108 until the teeth 111, 113 are aligned. Once the teeth 111, 113 are meshed, rotation of the moveable ring gear 108 is prevented, such that output speed is reduced and torque is amplified by the second planetary stage 68.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A power tool comprising:
a housing including a battery receptacle;
a motor disposed within the housing, the motor including a motor shaft driven by the motor about a first axis;
a battery configured to be coupled to the battery receptacle to power the motor;
a head coupled to the housing, the head containing a ratchet mechanism configured to rotate an output drive about an output axis orthogonal to the first axis, the head including a plurality of internal teeth formed on an inner circumferential surface of the head;
a transmission configured to transmit rotation from the motor shaft of the motor to the ratchet mechanism, the transmission shiftable between a high-speed, low-torque configuration and a low-speed, high-torque configuration, the transmission including:
a first planetary stage configured to receive torque from the motor shaft, and
a second planetary stage configured to receive torque from the first planetary stage, the second planetary stage including:
a plurality of planet gears configured to receive torque from an output of the first planetary stage,
a moveable ring gear configured to engage the plurality of planet gears, the moveable ring gear axially moveable along the first axis, the moveable ring gear including a plurality of outer teeth formed on an outer circumferential surface configured to engage the plurality of internal teeth of the head, and
a planet carrier configured to transfer torque to the ratchet mechanism;
a shift actuator positioned partially within the housing, the shift actuator moveable along an axis parallel to the first axis; and
a resiliently deformable spring lever coupled to the head, the moveable ring gear, and the shift actuator, the spring lever configured to transmit motion of the shift actuator to the moveable ring gear to shift the transmission between the high-speed, low-torque configuration and the low-speed, high-torque configuration.

2. The power tool of claim 1, wherein a speed of the output drive in the high-speed, low-torque configuration is equal to an output speed of the first planetary stage, and wherein the speed of the output drive in the low-speed, high-torque configuration is equal to an output speed of the second planetary stage.

3. The power tool of claim 1, wherein the moveable ring gear is rotatable about the first axis in a first position, and wherein the moveable ring gear is rotatably locked about the first axis in a second position.

4. The power tool of claim 1, wherein the moveable ring gear includes an annular recess formed on an outer circumferential surface of the moveable ring gear, wherein the annular recess receives a portion of the spring lever.

5. The power tool of claim 1, wherein the head includes a post configured to receive the spring lever, and wherein the spring lever rotates about the post.

6. The power tool of claim 1, wherein the shift actuator includes a user engageable portion extending through the housing in a direction orthogonal to the first axis.

7. A power tool comprising:
a motor including a motor shaft rotating around a first axis;
a ratchet mechanism configured to receive torque from the motor to rotate an output drive; and
a transmission coupled between the motor shaft and the ratchet mechanism, the transmission having a high-speed, low-torque configuration and a low-speed, high-torque configuration, the transmission including:
a first planetary stage configured to receive torque from the motor shaft, and
a second planetary stage configured to receive torque from the first planetary stage, the second planetary stage comprises:
a plurality of planet gears configured to receive torque from an output of the first planetary stage,
a moveable ring gear configured to engage the plurality of planet gears, the moveable ring gear is axially moveable along the first axis, the moveable ring gear including a plurality of outer teeth formed on an outer circumferential surface, and
a planet carrier configured to transfer torque to the ratchet mechanism.

8. The power tool of claim 7, further comprising:
a shift actuator moveable along an axis parallel to the first axis, and
a spring lever coupled to the moveable ring gear and the shift actuator, the spring lever configured to transmit motion of the shift actuator to the moveable ring gear to shift the transmission between the high-speed, low-torque configuration and the low-speed, high-torque configuration.

9. The power tool of claim 8, wherein the spring lever is resiliently deformable in response to resistance to axial movement of the moveable ring gear.

10. The power tool of claim 8, wherein the moveable ring gear includes an annular recess formed on an outer circumferential surface of the moveable ring gear, wherein the annular recess is configured to receive a portion of the spring lever.

11. The power tool of claim 7, wherein the moveable ring gear is rotatable about the first axis in a first position, and wherein the moveable ring gear is rotatably locked about the first axis in a second position.

12. A power tool comprising:
a housing;
a head coupled to the housing, the head housing a ratchet mechanism configured to rotate an output drive;
a motor disposed within the housing, the motor including a motor shaft driven by the motor about a first axis;
a transmission configured to transmit rotation from the motor shaft of the motor to the ratchet mechanism, the transmission shiftable between a high-speed, low-torque configuration and a low-speed, high-torque configuration;
a shift actuator positioned within the housing, the shift actuator is configured to move parallel to the first axis; and
a spring lever coupled to the head, the shift actuator, and a portion of the transmission, the spring lever configured to transmit motion of the shift actuator to a portion of the transmission to shift the transmission between the high-speed, low-torque configuration and the low-speed, high-torque configuration.

13. The power tool of claim 12, wherein the transmission includes a first planetary stage and a second planetary stage, and wherein the second planetary stage comprises a second plurality of planet gears, a moveable ring gear, and a second planet carrier.

14. The power tool of claim 13, wherein the moveable ring gear is axially moveable along the first axis between a first position corresponding to the high-speed, low-torque configuration of the transmission a second position corresponding to the low-speed, high-torque configuration of the transmission.

15. The power tool of claim 14, wherein the moveable ring gear includes a plurality of outer teeth formed on an outer circumferential surface of the moveable ring gear, and wherein the plurality of outer teeth of the moveable ring gear are configured to engage a plurality of internal teeth formed on an inner surface of the head when the moveable ring gear is in the second position.

16. The power tool of claim 15, wherein the spring lever is resiliently deformable in response to resistance to axial movement of the moveable ring gear.

17. The power tool of claim 16, wherein the resistance to axial movement of the moveable ring gear is a result of misalignment between outer teeth of the moveable ring gear and the internal teeth of the head.

18. The power tool of claim 14, wherein the moveable ring gear is rotatable about the first axis in the first position, and wherein the moveable ring gear is rotatably locked about the first axis in the second position.

19. The power tool of claim 13, wherein the moveable ring gear includes an annular recess formed on an outer circumferential surface of the moveable ring gear, wherein the annular recess receives a portion of the spring lever.

20. The power tool of claim 12, wherein the shift actuator includes a user engageable portion extending through the housing in a direction orthogonal to the first axis.
